(19) United States
(12) Patent Application Publication
(10) Pub. No.: US 2003/0234001 A1
(43) Pub. Date: Dec. 25, 2003

(54) Device for compensating pressure in a motor vehicle tank

(75) Inventors: Markus Eberle, Hammersbach (DE); Thomas Warm, Dieburg (DE)

Correspondence Address: Friedrich Kueffner, Suite 910, 317 Madison Avenue, New York, NY, 10017, US

(73) Assignee: Rasmussen GmbH

(21) Appl. No.: 10/463,954

(22) Filed: Jun. 18, 2003

(30) Foreign Application Priority Data
Jun. 21, 2002 (DE) 102 27 698.6

(51) Int. Cl. F02M 1/00

(52) U.S. Cl. 123/445

(57) ABSTRACT

A device for compensating pressure in a motor vehicle tank has a pressure compensation container made of plastic material and a fluid conduit made of plastic material. The fluid conduit is connected to the pressure compensation container, wherein the pressure compensation container is connectable via the fluid conduit to a tank of a motor vehicle. The pressure compensation container and the fluid conduit form a monolithic, seamless separate component.

### BACKGROUND OF THE INVENTION

1. Field of the Invention

The invention relates to a device for compensating the pressure in a motor vehicle. The device comprises a pressure compensation container comprised essentially of plastic material and a fluid conduit which is also comprised essentially of plastic material via which the pressure compensation container is connectable to the tank.

2. Description of the Related Art

In a known device of this kind, the pressure compensation container is configured together with the tank filling pipe as a rigid blow-molded part. In this device, the pressure compensation container and the tank filling pipe are connected by a welding seam which effects at the same time a division of the component into the pressure compensation container and the tank filling pipe. One end of the fluid conduit is connected with a connecting socket of the pressure compensation container and the other end of the fluid conduit is connected to a connecting socket on the tank. The fluid conduit serves for connecting the tank and the pressure compensation container when the pressure compensation container must be mounted distal to the tank for spatial reasons. The connection between the fluid conduit and the pressure compensation container is a plug-in connection which, like the seam between the tank filling pipe and the pressure compensation container, is not sufficiently permeation-tight with respect to diffusion of fluids such as gasoline, diesel fuel, and similar fuels. The common configuration of the pressure compensation container and of the tank filling pipe as a rigid (stiff) component makes a space-saving mounting in the motor vehicle more difficult.

### SUMMARY OF THE INVENTION

It is an object of the present invention to provide a device of the aforementioned kind which can be produced in a simpler way and can be mounted in a space-saving and easy way while it is more permeation resistant at the same time.

In accordance with the present invention, this is achieved in that the pressure compensation container and the fluid conduit are produced as a unitary or monolithic part without a seam as a separate component.

According to the present intention, a coupling between the fluid conduit and the pressure compensation container is no longer needed and, in this way, a separate coupling location for connecting the two parts is avoided and diffusion of the fuel at such a connecting location is prevented. Since the pressure compensation container and the fluid conduit form a separate component, they can be mounted in a space-saving way in accordance with the spatial conditions and independent of the arrangement of the tank filling pipe.

When, moreover, the pressure compensation container is embodied to be flexible, it can be more easily adapted to the available spatial conditions during mounting and can also yield to the gas pressure in the tank. The pressure compensation container is particularly flexible when it is configured as a corrugated pipe.

Moreover, the pressure compensation container and the fluid conduit can be configured together in a corrugation device as a corrugated pipe or member.

As an alternative, a vacuum forming process for producing the component comprised of the compensation container and the fluid conduit can be used. In this way, corrugations at the inner side and the outer side of the component can be formed.

When the pressure compensation container and the fluid conduit are of a multi-layer configuration, the materials of the individual layers can be selected such that they satisfy at least the most important requirements of the component, in particular, the desired diffusion barrier action.

### BRIEF DESCRIPTION OF THE DRAWING

In the drawing:

FIG. 1 shows a perspective view of a device according to the invention;

FIG. 2 is a view of one end of the pressure compensation container of the device of the present invention shown in section with a coupling member inserted therein;

FIG. 3 shows the detail A of FIG. 1 according to a modification of the device according to the present invention; and

FIG. 4 shows a second embodiment of a device according to the invention.

### DESCRIPTION OF THE PREFERRED EMBODIMENTS

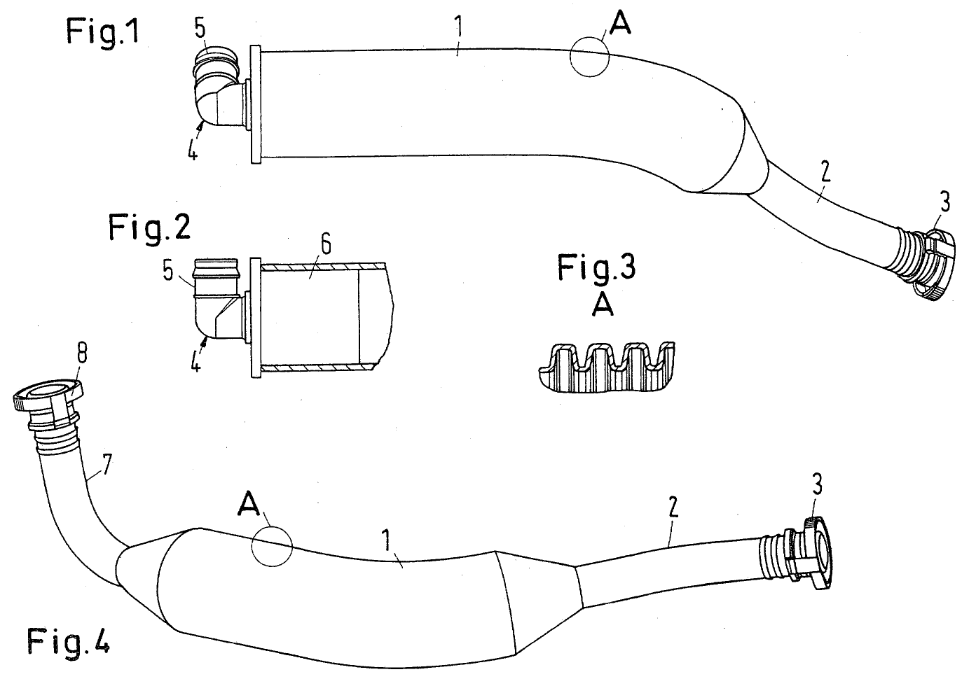

According to FIGS. 1 and 2, the device according to the invention for compensating the pressure in a motor vehicle tank is comprised of a pressure compensation container 1 and a fluid conduit 2 which are produced together as a unitary or monolithic separate component without a seam.

The pressure compensation container 1 is comprised of flexible plastic material. The fluid conduit 2 is also comprised of flexible plastic material. The walls of the pressure compensation container 1 and of the fluid conduit 2 are smooth; alternatively, they can also be corrugated as illustrated in the detail shown in FIG. 3.

In comparison to conventional devices comprised of a pressure compensation container and a fluid conduit, the coupling between the pressure compensation container and the fluid conduit is no longer present and the resulting diffusion of fuel vapors through the connecting location of the coupling, which is conventionally embodied as a plug-in coupling with O-rings functioning as sealing rings or gaskets between the two coupling members, does not take place.

At the free end of the fluid conduit 2, a coupling member 3 is attached. The coupling member 3 has a ribbed pipe member which is fixedly pressed into the fluid conduit 2. The tank (not illustrated) of the motor vehicle has a connecting socket which fits into the coupling member 3 so that a plug-in coupling results which is detachable.

At the free end of the pressure compensation container 1, there is also a coupling member 4 which is provided with a ribbed pipe member 5 for connecting a coupling member of an active carbon filter and a cylindrical pipe member 6 for receiving a check valve; the check valve will shut off the connection to the tank in the case of a rollover of the vehicle.

The single-part (monolithic) configuration of the pressure compensation container 1 and of the fluid conduit 2 can be produced by a blow-molding process but also by injection molding. A device in the form of a corrugated pipe, of which a detail is illustrated in FIG. 3, can be produced in a corrugating device. A corrugated pipe is particularly flexible and can be easily mounted in a motor vehicle in accordance with the spatial conditions of the motor vehicle.

The embodiment according to FIG. 4 differs from that in FIGS. 1 and 2 only in that, instead of the coupling member 4, a second fluid conduit 7 is formed as a unitary part of the pressure compensation container 1 and that the free end of the fluid conduit 7 is provided with a coupling member 8 configured in the same way as the coupling member 3 when the active carbon filter is provided with a matching coupling member, like the coupling member 4 of FIGS. 1 and 2. The coupling member 8 can also comprise a check valve for automatically shutting off the tank in a rollover situation of the motor vehicle.

In the device according to FIG. 4, the pressure compensation container 1 and the fluid conduits 2 and 7 can be configured in the same way as the device according to FIG. 1 with smooth walls or as a corrugated pipe with corrugations according to FIG. 3. The manufacture can also be realized by vacuum forming or in a corrugation device.

A further configuration or modification can reside in that the pressure compensation container 1, the fluid conduit 2, and the fluid conduit 7 are of a multi-layer configuration. In this way, the materials of the individual layers can be selected such that they satisfy at least the most important requirements of the component, in particular, the desired ability to provide a diffusion barrier.

While specific embodiments of the invention have been shown and described in detail to illustrate the inventive principles, it will be understood that the invention may be embodied otherwise without departing from such principles.

What is claimed is:

1. A device for compensating pressure in a motor vehicle tank, comprising:
a pressure compensation container comprised essentially of plastic material;
a fluid conduit comprised essentially of plastic material and connected to the pressure compensation container;
wherein the pressure compensation container is connectable via the fluid conduit to a motor vehicle tank;
wherein the pressure compensation container and the fluid conduit form a monolithic, seamless separate component.

2. The device according to claim 1, wherein the pressure compensation container is flexible.

3. The device according to claim 1, wherein the pressure compensation container is a corrugated pipe.

4. The device according to claim 1, wherein the pressure compensation container and the fluid conduit together form a corrugated pipe produced in a corrugation device.

5. The device according to claim 1, wherein the pressure compensation container and the fluid conduit are produced together by vacuum forming.

6. The device according to claim 1, wherein the pressure compensation container and the fluid conduit are multi-layered.
